(19) United States
(12) Patent Application Publication
(10) Pub. No.: US 2026/0364772 A1
(43) Pub. Date: Nov. 19, 2026

(54) COMBINATION LADDER AND MECHANIC CREEPER APPARATUS

(71) Applicants: Jeremy Herbert, Ham Lake, MN (US); Misti Herbert, Ham Lake, MN (US)

(72) Inventors: Jeremy Herbert, Ham Lake, MN (US); Misti Herbert, Ham Lake, MN (US)

(21) Appl. No.: 19/208,949

(22) Filed: May 15, 2025

(51) Int. Cl. B25H 5/00; E06C 1/12; E06C 1/20

(52) U.S. Cl. CPC B25H 5/00; E06C 1/12; E06C 1/20

(57) ABSTRACT

A combination ladder and mechanic creeper apparatus for use as a step ladder, an extension ladder, and a mechanic creeper includes a support frame and a ladder section which are pivotably attached to each other. The support frame and the ladder section may be positioned in a step ladder configuration in which the support frame forms an acute angle with the ladder section, and rungs on the ladder section are oriented at an incline when the apparatus is placed on a floor surface. The support frame and the ladder section may be positioned in a mechanic creeper configuration in which the support frame lies atop the ladder section and may be supported on the floor surface via wheels attached to the ladder section. A platform attached to the support frame supports a user in the mechanic creeper configuration. An extension ladder section is slidably attached to the ladder section.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to ladders and mechanic creepers and more particularly pertains to a new combination ladder and mechanic creeper for use as a step ladder, an extension ladder, and a mechanic creeper.

### (2) Description of Related Art including information disclosed under 37 CFR 1.97 and 1.98.

The prior art relates to ladders and mechanic creepers, including combinations of step ladders and extension ladders and combinations of ladders and wheeled carts. The prior art fails, however, to describe an apparatus in which a support frame and a ladder section are pivotably coupled to each other and an extension ladder section is slidably mounted to the ladder section. Such an apparatus may be positioned in a step ladder configuration in which the support frame and the ladder section from an inverted V-shape and rungs on the ladder section enable climbing above a floor surface. Such an apparatus may be folded such that a platform attached to the support frame may be supported above the ladder section, and wheels on the ladder section may enable a user to roll under a vehicle while resting on the platform. Finally, the extension ladder section may be positioned with respect to the ladder section to form a ladder that may be leaned against the vehicle or a wall surface such that the user may scale the vehicle or wall surface.

### BRIEF SUMMARY OF THE INVENTION

An embodiment of the disclosure meets the needs presented above by generally comprising a support frame which is elongated between a bottom end and a top end. The support frame has a front side and a back side which extend between the bottom end and the top end. A ladder section is coupled to the support frame and is elongated between a lower end and an upper end. The ladder section has a forward side and a backward side which extend between the lower end and the upper end. The upper end is positioned adjacent to the top end of the support frame and is pivotable at the upper end with respect to the support frame. The ladder section comprises a pair of ladder rails and a plurality of ladder rungs, wherein the ladder rungs are coupled to and extend between the pair of ladder rails. A platform is coupled to the support frame and has a support surface facing away from the back side of the support frame. A plurality of wheels is mounted to the ladder section and is spaced forwardly of the ladder section.

The support frame and the ladder section are positionable in a step ladder configuration in which the support frame forms an acute angle with the ladder section. The bottom end of the support frame and the lower end of the ladder section are configured to be positionable on a floor surface when the support frame and the ladder section are positioned in the step ladder configuration. The support frame and the ladder section are also positionable in a mechanic creeper configuration in which the support frame lies against the backward side of the ladder section. The wheels are configured to be positionable on the floor surface such that the support surface of the platform faces upwardly when the support frame and the ladder section are in the mechanic creeper configuration.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear perspective view of a combination ladder and mechanic creeper apparatus according to an embodiment of the disclosure in which a support frame and a ladder section are positioned in a step ladder configuration.

FIG. 2 is a front perspective view of an embodiment of the disclosure in which a support frame and a ladder section are positioned in a step ladder configuration.

FIG. 3 is a front perspective view of an embodiment of the disclosure in which an extension ladder section is positioned in an extended position with respect to the ladder section.

FIG. 4 is a perspective view of an embodiment of the disclosure in which a support frame and a ladder section are positioned in a mechanic creeper configuration.

FIG. 5 is an in-use view of an embodiment of the disclosure in which a support frame and a ladder section are positioned in a mechanic creeper configuration.

### DETAILED DESCRIPTION OF THE INVENTION

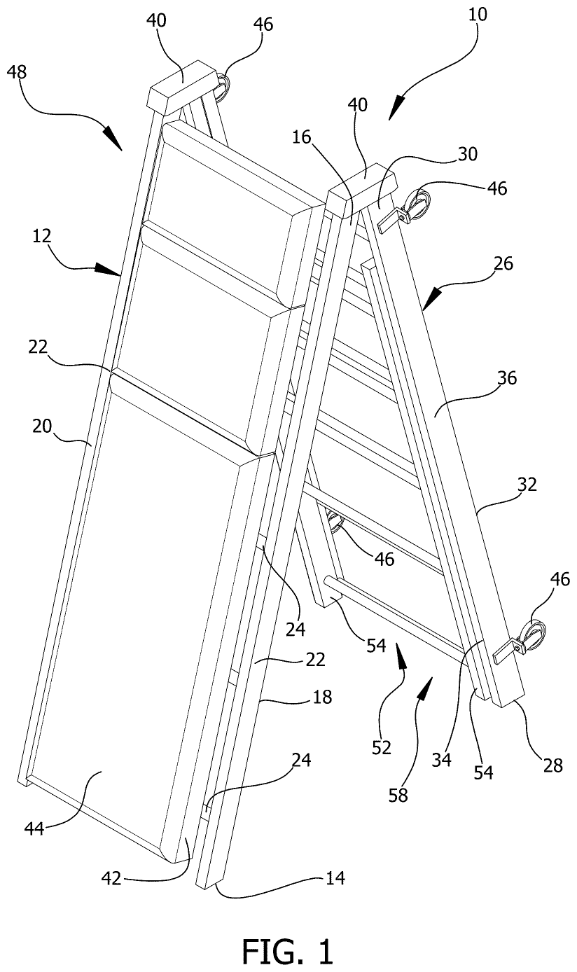

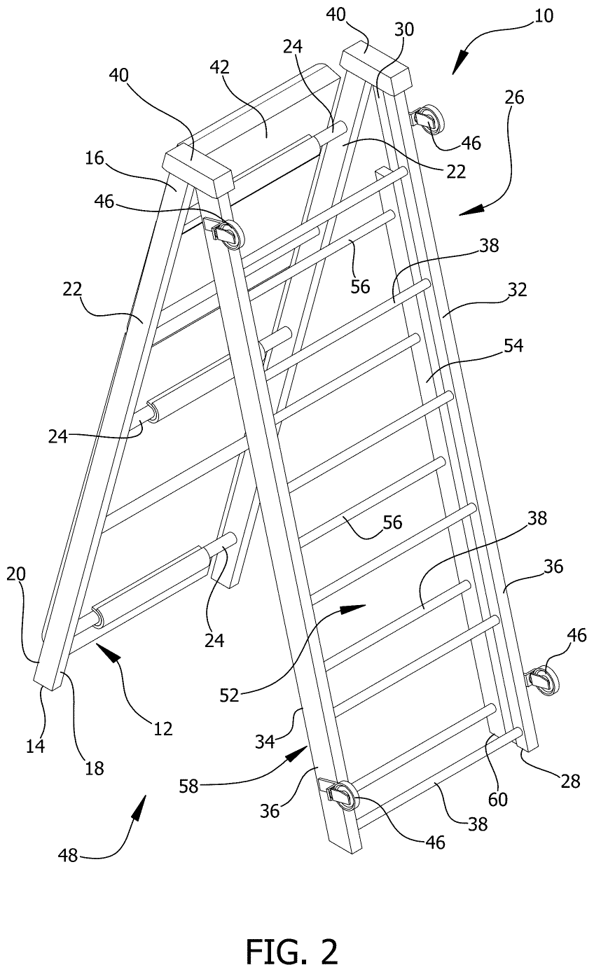

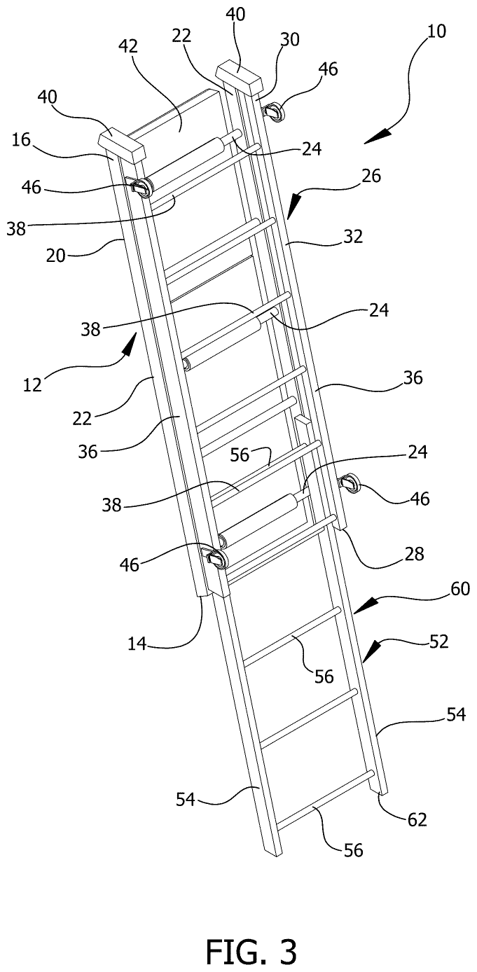

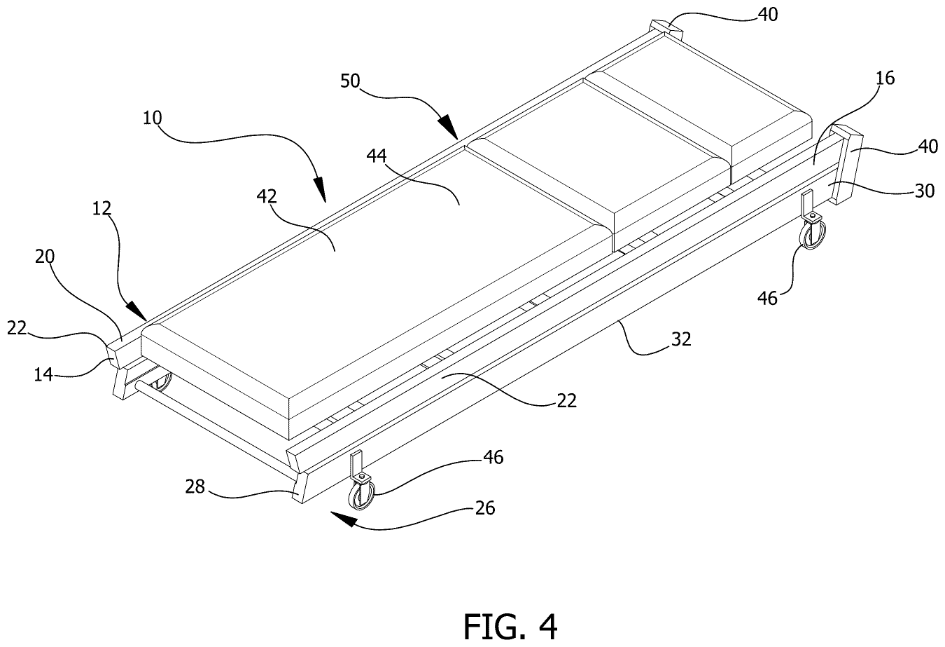

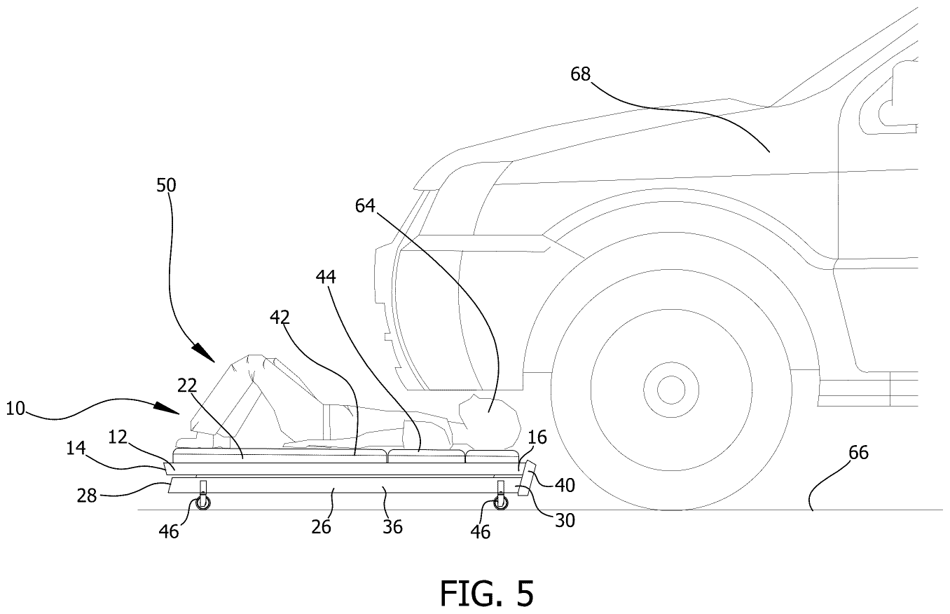

With reference now to the drawings, and in particular to FIGS. 1 through 5 thereof, a new combination ladder and mechanic creeper embodying the principles and concepts of an embodiment of the disclosure and generally designated by the reference numeral 10 will be described.

As best illustrated in FIGS. 1 through 5, the combination ladder and mechanic creeper apparatus 10 generally comprises a support frame 12 which is elongated between a bottom end 14 and a top end 16. The support frame 12 has a front side 18 and a back side 20 which extend between the bottom end 14 and the top end 16. The support frame 12 comprises a pair of support rails 22 and a plurality of support bars 24, wherein the support bars 24 are coupled to and extend between the pair of support rails 22.

A ladder section 26 coupled to the support frame 12 and is elongated between a lower end 28 and an upper end 30. The ladder section 26 has a forward side 32 and a backward side 34 which extend between the lower end 28 and the upper end 30. The upper end 30 is positioned adjacent to the top end 16 of the support frame 12, and the ladder section 26 is pivotable at the upper end 30 with respect to the support frame 12. The ladder section 26 comprises a pair of ladder rails 36 and a plurality of ladder rungs 38, wherein the ladder rungs 38 are coupled to and extend between the pair of ladder rails 36. The ladder rungs 38 are evenly spaced from each other between the lower end 28 and the upper end 30 of the ladder section 26.

A pair of cap members 40 couple the support frame 12 to the ladder section 26. Each cap member 40 is coupled to an associated support rail 22 of the pair of support rails 22 of the support frame 12 and an associated ladder rail 36 of the pair of ladder rails 36 of the ladder section 26. The support frame 12 is pivotable with respect to the pair of cap members 40, but the ladder section 26 may be pivotable with respect to the pair of cap members 40 in other embodiments.

A platform 42 is coupled to the support frame 12 and has a support surface 44 which faces away from the back side 20 of the support frame 12. The platform 42 may be removably attached to the support rails 22 of the support frame 12 via fasteners which wrap around the support bars 24 and include hook-and-loop fasteners, snap buttons, zippers, or the like to secure themselves around the respective support bars 24. A plurality of wheels 46 is mounted to the ladder section 26 and is spaced forwardly of the ladder section 26.

The support frame 12 and the ladder section 26 are positionable in a step ladder configuration 48 in which the support frame 12 forms an acute angle with the ladder section 26. The bottom end 14 of the support frame 12 and the lower end 28 of the ladder section 26 are configured to be positionable on a floor surface 66 when the support frame 12 and the ladder section 26 are positioned in the step ladder configuration 48. The support frame 12 and the ladder section 26 may be secured in the step ladder configuration 48 by the support frame 12 abutting interior surfaces of the cap members 40 such that the support frame 12 is prevented from pivoting farther away from the ladder section 26. The support frame 12 and the ladder section 26 may be secured in the step ladder configuration 48 by a toggle linkage, a latch, a clamp, or another suitable fastener in other embodiments.

The support frame 12 and the ladder section 26 are also positionable in a mechanic creeper configuration 50 in which the support frame 12 lies against the backward side 34 of the ladder section 26. The wheels 46 are configured to be positionable on the floor surface 66 such that the support surface 44 of the platform 42 faces upwardly when the support frame 12 and the ladder section 26 are in the mechanic creeper configuration 50.

An extension ladder section 52 is slidably coupled to the ladder section 26. The extension ladder section 52 comprises a pair of extension ladder rails 54 and a plurality of extension ladder rungs 56, wherein the ladder rungs 38 are coupled to and extend between the pair of extension ladder rails 54. The extension ladder rungs 56 are evenly spaced from each other along the pair of extension ladder rails 54. The extension ladder section 52 is movable between a retracted position 58 and an extended position 60 with respect to the ladder section 26. A downward end 62 of the extension ladder section 52 is positioned adjacent to the lower end 28 of the ladder section 26 when the extension ladder is positioned in the retracted position 58. The extension ladder section 52 extends downwardly from the ladder section 26 when in the extended position 60.

In use, the support frame 12 and the ladder section 26 may be positioned in the step ladder configuration 48 such that a user 64 may climb the ladder section 26 when placed on the floor surface 66. The support frame 12 and the ladder section 26 may be positioned in the mechanic creeper configuration 50 such that the user 64 may lie on the support surface 44 of the platform 42 and roll the wheels 46 across the floor surface 66 underneath a vehicle 68. The extension ladder section 52 may be adjusted between the retracted position 58 and the extension position to adjust a distance across which the user 64 may climb during use of the device. Conventional rung locks or other suitable locking means may be used to secure the extension ladder section 52 to a selected position with respect to the ladder section 26. Other suitable locking means may include clamps, latches, pins, or the like. A rope and pully may be used to facilitate positioning of the extension ladder section 52 with respect to the ladder section 26 as is typical for conventional extension ladders.

The extension ladder section 52 may be placed on the floor surface 66 and the combination ladder and mechanic creeper apparatus 10 may be leaned against the vehicle 68, a wall surface, or the like via the platform 42, the support frame 12, the backward side 34 of the ladder section 26, or the like. While used in this manner, the support frame 12 may be positioned at any of a variety of angles with respect to the ladder section 26. The support frame 12 may be positioned to lie over the backward side 34 of the ladder section 26 and may be secured in this position via a pin, a latch, a threaded fastener, a magnet, or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A combination ladder and mechanic creeper apparatus comprising:
a support frame, the support frame being elongated between a bottom end and a top end, the support frame having a front side and a back side which extend between the bottom end and the top end;
a ladder section coupled to the support frame, the ladder section being elongated between a lower end and an upper end, the ladder section having a forward side and a backward side which extend between the lower end and the upper end, the upper end being positioned adjacent to the top end of the support frame, the ladder section being pivotable at the upper end with respect to the support frame, the ladder section comprising a pair of ladder rails and a plurality of ladder rungs, the plurality of ladder rungs being coupled to and extending between the pair of ladder rails;
a platform coupled to the support frame, the platform having a support surface facing away from the back side of the support frame;
a plurality of wheels mounted to the ladder section, the plurality of wheels being spaced forwardly of the ladder section;
wherein the support frame and the ladder section are positionable in a step ladder configuration in which the support frame forms an acute angle with the ladder section, the bottom end of the support frame and the lower end of the ladder section being configured to be positionable on a floor surface when the support frame and the ladder section are positioned in the step ladder configuration; and
wherein the support frame and the ladder section are positionable in a mechanic creeper configuration in which the support frame lies against the backward side of the ladder section, the wheels being configured to be positionable on the floor surface such that the support surface of the platform faces upwardly when the support frame and the ladder section are in the mechanic creeper configuration.

2. The combination ladder and mechanic creeper apparatus of claim 1, wherein the support frame comprises a pair of support rails and a plurality of support bars, the plurality of support bars being coupled to and extending between the pair of support rails.

3. The combination ladder and mechanic creeper apparatus of claim 2, further comprising a pair of cap members coupling the support frame to the ladder section, each cap member of the pair of cap members being coupled to an associated support rail of the pair of support rails of the support frame and an associated ladder rail of the pair of ladder rails of the ladder section.

4. The combination ladder and mechanic creeper apparatus of claim 1 wherein the ladder rungs of the plurality of ladder rungs are evenly spaced from each other between the lower end and the upper end of the ladder section.

5. The combination ladder and mechanic creeper apparatus of claim 1, further comprising an extension ladder section slidably coupled to the ladder section, the extension ladder section comprising a pair of extension ladder rails and a plurality of extension ladder rungs, the plurality of extension ladder rungs being coupled to and extending between the pair of extension ladder rails.

6. The combination ladder and mechanic creeper apparatus of claim 5, wherein the extension ladder rungs of the plurality of extension ladder rungs are evenly spaced from each other along the pair of extension ladder rails, the extension ladder section being movable between a retracted position and an extended position with respect to the ladder section, a downward end of the extension ladder section being positioned adjacent to the lower end of the ladder section when the extension ladder is positioned in the retracted position, the extension ladder section extending downwardly from the ladder section when in the extended position.

7. A combination ladder and mechanic creeper apparatus comprising:
a support frame, the support frame being elongated between a bottom end and a top end, the support frame having a front side and a back side which extend between the bottom end and the top end, the support frame comprising a pair of support rails and a plurality of support bars, the plurality of support bars being coupled to and extending between the pair of support rails;
a ladder section coupled to the support frame, the ladder section being elongated between a lower end and an upper end, the ladder section having a forward side and a backward side which extend between the lower end and the upper end, the upper end being positioned adjacent to the top end of the support frame, the ladder section being pivotable at the upper end with respect to the support frame, the ladder section comprising a pair of ladder rails and a plurality of ladder rungs, the plurality of ladder rungs being coupled to and extending between the pair of ladder rails, the plurality of ladder rungs being evenly spaced from each other between the lower end and the upper end of the ladder section;
a pair of cap members coupling the support frame to the ladder section, each cap member of the pair of cap members being coupled to an associated support rail of the pair of support rails of the support frame and an associated ladder rail of the pair of ladder rails of the ladder section;
a platform coupled to the support frame, the platform having a support surface facing away from the back side of the support frame;
a plurality of wheels mounted to the ladder section, the plurality of wheels being spaced forwardly of the ladder section;
wherein the support frame and the ladder section are positionable in a step ladder configuration in which the support frame forms an acute angle with the ladder section, the bottom end of the support frame and the lower end of the ladder section being configured to be positionable on a floor surface when the support frame and the ladder section are positioned in the step ladder configuration;
wherein the support frame and the ladder section are positionable in a mechanic creeper configuration in which the support frame lies against the backward side of the ladder section, the wheels being configured to be positionable on the floor surface such that the support surface of the platform faces upwardly when the support frame and the ladder section are in the mechanic creeper configuration; and
an extension ladder section slidably coupled to the ladder section, the extension ladder section comprising a pair of extension ladder rails and a plurality of extension ladder rungs, the plurality of extension ladder rungs being coupled to and extending between the pair of extension ladder rails, the plurality of extension ladder rungs being evenly spaced from each other along the pair of extension ladder rails, the extension ladder section being movable between a retracted position and an extended position with respect to the ladder section, a downward end of the extension ladder section being positioned adjacent to the lower end of the ladder section when the extension ladder is positioned in the retracted position, the extension ladder section extending downwardly from the ladder section when in the extended position.
